(19) United States
(12) Patent Application Publication
(10) Pub. No.: US 2015/0356643 A1
(43) Pub. Date: Dec. 10, 2015

(54) Dual-Identity Review System

(71) Applicant: VendOp, LLC, San Francisco, CA (US)

(72) Inventors: Andrew Kohm, Foster City, CA (US); David Blado, Los Gatos, CA (US)

(21) Appl. No.: 14/730,299

(22) Filed: Jun. 4, 2015

Related U.S. Application Data
(60) Provisional application No. 62/007,515, filed on Jun. 4, 2014.

(51) Int. Cl. G06Q 30/02; H04L 29/06

(52) U.S. Cl. CPC G06Q 30/0282; H04L 63/0421

(57) ABSTRACT

Embodiments of the present disclosure provide methods and systems for anonymizing the identity of users of an online system. A request to interact with the online system is received from a viewing user. A determination is made whether the request is for interacting with another user of the online system. If the request is to interact with another users, the online system uses the real identity of the viewing user for the interaction. Otherwise, if the request is not for interaction with another user of the online system, the online system uses an anonymized identity of the viewing user.

### PRIORITY

This application claims the benefit of U.S. Provisional Application 62/007,515, filed Jun. 4, 2014, which is herein incorporated by reference in its entirety,

### BACKGROUND

The disclosure generally relates to the field of vendor referral systems and more specifically to anonymizing and de-anonymizing the identity of users of the vendor referral system.

Some online systems allow users to provide reviews to other users of the online system, For instance, users may be able to provide reviews to restaurants they have tried. Having personal information the associates the review to the real identity of the reviewing user may deter users from posting comments in the online system, or influence the review that the reiewing user provides. For instance, users may be less inclined to leave negative reviews to restaurants that they did not believe provided a good service.

To remediate the above described problem, some online systems use anonymized identities, where a user is identified by a username that is unrelated to the user's real identity. A drawback of anonymous profiles is that since does not identify the real identity of a user, the user may abuse use certain features of the online system. For instance, a user with an anonymous profile may send spamming messages to users of the online system. If the spamming user is blocked from the system, the spamming user may create a new account with the online system and repeat the previous behavior that lead the user from being blocked from the online system. As such, real profiles deter users from misusing or overusing the features of the online system.

### SUMMARY

Embodiments of the present disclosure provide methods and systems for anonymizing the identity of users of an online system. A request to interact with the online system is received from a viewing user. A determination is made whether the request is for interacting with another user of the online system. If the request is to interact with another users, the online system uses the real identity of the viewing user for the interaction. Otherwise, if the request is not for interaction with another user of the online system, the online system uses an anonymized identity of the viewing user.

### BRIEF DESCRIPTION OF DRAWINGS

FIG. 1 is a block diagram of a system environment in which a vendor referral system operates, in accordance with an embodiment of the vendor referral system.

FIG. 2 is a block diagram of a vendor referral system, in accordance with an embodiment of the vendor referral system.

FIG. 3 is a block diagram of a user profile, in accordance with an embodiment of the vendor referral system.

FIG. 4A is a user interface of a vendor search in the vendor referral system, in accordance with an embodiment of the vendor referral system.

FIG. 4B is a user interface of the vendor search with a site filter set to “legal,” in accordance with an embodiment of the vendor referral system.

FIG. 5A is a user interface showing reviews for a vendor, in accordance with an embodiment of the vendor referral system.

FIG. 5B is a user interface showing reviews for a vendor with a site filter set to “legal,” in accordance with an embodiment of the vendor referral system.

FIG. 6 is a flow diagram of a method for using a dual identity, in accordance with an embodiment of the vendor referral system.

FIG. 7 is a flow diagram of a method for determining eligibility of a user review, in accordance with an embodiment of the vendor referral system.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Architecture

Finding the appropriate vendor for a specific job may be a difficult task. For the specific job, tens of different vendors with various levels of expertise and price may be available. Oftentimes trustworthy information about the different vendors is not readily available. A vendor referral system allows users to interact with vendors on the vendor referral system using multiple identifies. The users may provide anonymous comments for vendors to review a vendor, and use a real identity to solicit vendors or contact vendors directly. Additionally, the vendor referral system allows users to view comments for vendors, provided by other users that have used the vendors in the past. To protect itself from malicious, anonymized reviews, a vendor may set rules for submitting a review. The rules are enforced by the vendor referral system, which knows real identity information about users. Thus, a vendor may specify that certain other companies are competitors, and the vendor referral system prevents reviews by employees of those competitors. Users may also select a site-wide filter for information on the vendor referral system, in order to limit companies and reviews to specific industries. For example, a site filter for “legal” may be applied to limit reviews viewed by the user to reviewers that are associated with legal field. These and further features are described in more detail below.

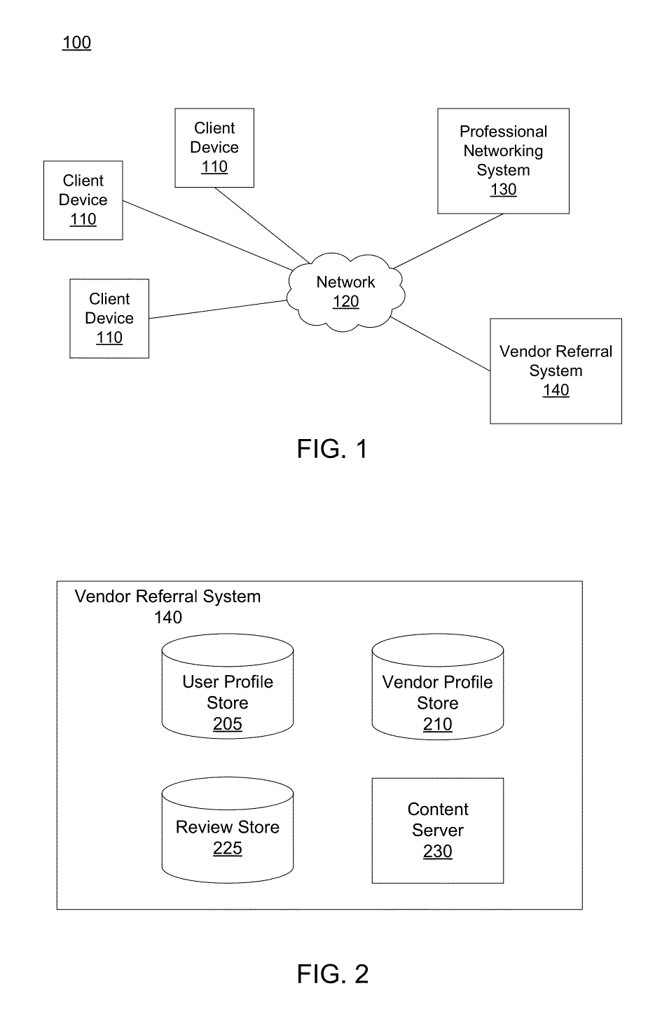

FIG. 1 is a block diagram of a system environment 100 for a vendor referral system 140. The system environment 100 shown by FIG. 1 comprises one or more client devices 110, a network 120, a professional networking system 130, and the vendor referral system 140. In alternative configurations, different and/or additional components may be included in the system environment 100. Further, the embodiments described herein can be adapted to online systems that are not vendor referral systems.

The client devices 110 are one or more computing devices capable of receiving user input as well as communicating via the network 120. In one embodiment, a client device 110 is a conventional computer system, such as a desktop or a laptop computer. Alternatively, the client device 110 may be a device having computer functionality, such as a personal digital assistant (PDA), a mobile telephone, a smartphone or another suitable device. The client device 110 is configured to communicate via the network 120. In one embodiment, the client device 110 executes an application allowing a user of the client device 110 to interact with the vendor referral system 140. For example, the application may be a web browser that can communicate with many systems, or may be a specialized application designed specifically to communicate with the vendor referral system, such as through an application programming interface (API).

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

In one embodiment, the professional networking system 130 stores professional information about users. For instance, the professional networking system 130 may store information related to a user's education, work experience, skills, and the like. The professional networking system 130 may be coupled to the network 120 for communication with the vendor referral system 140, which is further described below in conjunction with FIG. 2. In some embodiments, the professional networking system 130 also stores connections between users of the professional networking system 130.

FIG. 2 is a block diagram of an architecture of the vendor referral system 140. The vendor referral system 140 allows users to connect with vendors in various ways. For example, users may search for vendors, provide and view comments for vendors, and contact vendors of interest. The vendor referral system 140 shown in FIG. 2 includes a user profile store 205, a vendor profile store 210, a review store 225, and a web server 230. In other embodiments, the vendor referral system 140 may include additional, fewer, or different components for various applications. Conventional components such as network interfaces, security functions, load balancers, failover servers, management and network operation consoles, and the like are not shown so as to not obscure the details of the system architecture.

The vendor profile store 210 stores information related to different vendors registered with the vendor referral system 140. For instance, the vendor profile store 210 may store descriptive information, such as, the vendor's name, address, phone number, web page, business type, and the like. In some embodiments, the vendor profiles are created by each vendor. For instance, a vendor may register with the vendor referral system. During the registration process, a vendor may provide information the vendor wants users to see to the vendor referral system 140. For instance, a vendor may provide a list of the vendor's expertise, one or more case studies, etc.

In other embodiments, users may create a vendor profile for vendors that are not registered with the vendor referral system 140. For instance, a user may want to provide a review for a vendor that is not registered with the vendor referral system 140. The user may provide the vendor referral system 140 with basic information about the vendor, such as the vendor's name, address, phone number, and the like. The vendor referral system 140 creates a vendor profile and allows users to interact with this user-entered vendor like a normal vendor. In some embodiments, vendors may claim ownership of a vendor profile created by a user posting a review for the vendor. For instance, a vendor may find that a vendor profile created by a user of the vendor referral system already exists and may claim ownership of the vendor profile. The vendor may then provide with additional information that was not provided by the user, such as contact information, a logo, and the like. When users interact with a vendor profile that has not been entered or claimed by a vendor, an icon or other indication may be displayed to users indicating that the vendor is user-entered and the information may not be reliable. In one embodiment, after a user created a vendor profile for a vendor that is not registered with the vendor referral system 140, the vendor referral system contacts the vendor so that the vendor can claim ownership of the vendor profile or verify the information provided by the user.

In some embodiments, the vendor profile store 210 may also include a list of competitors for the vendor. For example, the vendor profile store 210 may store a list of the top 5 competitors of the vendor. In one embodiment, the vendor profile store 210 may additionally store a score for each competitor indicating the level of competition between the vendors. For instance, a score of 10 may indicate that the competitor is a direct competitor of the vendor, while a lower score may indicate that the competitor is an indirect competitor. For example, an inexpensive fast food restaurant may designate a nearby second fast food restaurant as a competitor with a score of 10, and designate an upscale restaurant with a different cuisine as a competitor with a score of 4.

In some embodiments, the list of competitors is provided by each vendor. For instance, a first vendor may identify the first vendor's top 5 competitors and provide this information to the vendor referral system 140. In some embodiments, the association between vendor and competitor is unilateral. For example, if a first vendor indicates that a second vendor is a competitor, the first vendor is not considered to be a competitor of the second vendor unless the second vendor indicates that the first vendor is a competitor. In other embodiments, the association between vendors is bilateral. For example, if a first vendor indicates that a second vendor is a competitor, the vendor referral system also considers the first vendor to be a competitor of the second vendor.

Vendors may also be associated with different businesses or business units. For example a large multinational computing company may be associated with various types of software, hardware, servers, business consulting, and financing. These various types of businesses are referred to as industries. Vendors are associated with one or more industries. For instance one vendor may be associated with the “catering” industry. Another vendor may be associated with the “legal” industry. Yet another vendor may be associated with the “graphic design” industry and the “marketing” industry. In one embodiment, the vendor referral system 140 associates a vendor profile with one industry and creates multiple vendor profiles, each associated with a different industry, for vendors that are associated with multiple industries. For instance, for the vendor that is associated with the industries “graphic design” and “marketing,” the vendor referral system would create a first vendor profile associated with the “graphic design” industry, and a second vendor profile associated with the “marketing” industry.

In addition, the list of competitors may also be specified as relating to a particular industry. The large computing company may have a group of competitors in the software industry, and another group of competitors in the hardware industry. It is possible that the group of competitors in the hardware industry are often customers in the software portion of the business, and vice versa. In some embodiments, a vendor specifies a list of competitors for each industry the vendor is associated with. For example, a vendor that is associated with the “graphic design” industry and the “marketing” industry may specify a list of the top 5 competitors in the “graphic design” industry and a list of the top 5 competitors in the “marketing” industry.

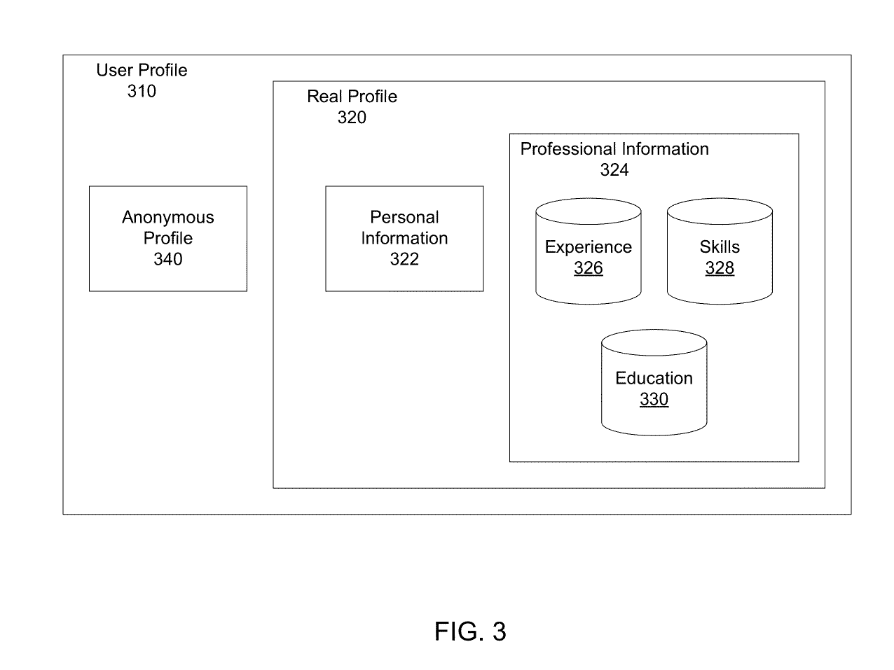

Each user of the vendor referral system 140 is associated with a user profile, which is stored in the user profile 205. In one embodiment, a user profile includes multiple data fields, each describing one or more attributes of the corresponding social networking system user. FIG. 3 shows an example user profile.

The user profile 310 of FIG. 3 includes a real profile 320 and an anonymous profile 340. The real profile 320 may include personal information 322 and professional information 324.

The anonymous profile 340 may be used to allow users to interact with the vendor referral system without exposing the user's real identity. Users may be more willing to provide more accurate reviews for vendors if the identity of the user is not exposed with the review. For instance, users associated with a real identity (i.e., the user's real name) may tone down a review or be more political when providing a review for a vendor that did not perform as expected. The user may express the user's true opinion more freely when an association between the real identity of the user is not shown to users reading the review.

The real profile 320 of a user may be used for direct interactions involving the user. For instance, the real profile 320 may be used when the user is directly interacting with a vendor the user found through the vendor referral system 140.

Personal information 322 may include descriptive information associated with a user of the vendor referral system. For example, personal information 322 may include first name, last name, date of birth, gender, and the like. Personal information 322 may include information explicitly provided by a user. Personal information 322 may also include information obtained from a third party system such as the professional networking system 130.

Professional information 324 includes information related to a user's professional life. For instance, professional information 324 may include information related to the user's work experience 326, such as prior employers, current employers, educational background 330, skills 328, and the like. Employers may be associated with particular vendors, dates of service, job titles, and the like. A user's educational background 330 may include schools or programs that the user attended, degrees awarded to the user, credentials of the user, awards, and so forth relating to the user's educational qualifications. Skills 328 may describe additional areas of proficiency of the user, which may be provided by other users in describing the user, for example as an endorsement of the user in a particular area or for a particular skillset, such as “patent prosecution” or “graphene.”

In some embodiments, the professional information 324 is associated with one or more industries. For instance, a user who works in a law firm may be associated with the “legal” industry. The industry associated with the professional information may be obtained from the professional networking system 130, or may be determined by the vendor referral system 140 based on information from the professional networking system 130. For instance, the vendor referral system 140 may determine an industry associated with the professional information 324 based on the work experience of the user, the skills of the user or the education history of the user.

In some embodiments, the professional information 324 is stored locally within the vendor referral system 140. For example, the vendor referral system 140 obtains user information from the professional networking system 130 and stores it locally. The vendor referral system may subsequently update the user information by accessing the user profile at the professional networking system 130. In other embodiments, the vendor referral system does not store information from the professional networking system 130. In these embodiments, the vendor referral system 140 accesses the user profile information from the professional networking system 130 when needed. For instance, a user may give permission to the vendor referral system 140 to access user information from the professional networking system 130 and provide access credentials to the professional networking system 130.

The anonymous profile 340 includes an identifier for a user of a user profile 310 to identify the user without reference to the real profile 320. The anonymous profile 340 may uniquely identify the user of the user profile 310. The anonymous profile 340 may, for example, include a user name that is unrelated to the real identity of the user. The user name may be selected by the user, or may be provided by the vendor referral system. For instance, a user named “Paul Smith” may select a user name for the anonymous profile to be “MFun.”

In some embodiments, the vendor referral system 140 may include one or more rules that limit the user name that may be selected for the anonymous profile. For instance, the vendor referral system 140 may limit the user name that may be selected by a user based on information included in the real profile 320. This may be used to prevent the user from selecting an anonymous profile 340 user name that can be used to identify a user's real professional information 324. For instance, the vendor referral system may specify that a user may not use three or more consecutive letters of the user's first name or last name.

In some embodiments, users are associated with groups. For instance, a user may be associated with the “Asian American Bar Association of the Greater Bay Area” group. A user may be associated with multiple groups. For example, a user is associated with the “Y Combinator” group and the “Silicon Valley Startups group”.

Groups may have one or more group managers. In some embodiments, a user is added to a group by the group manager. In other embodiments, a user requests to be added to a group and the group manager may approve or reject the user's request to be added to the group. In yet other embodiments, users a member of a group may invite a user that is not associated with the group to join the group. In this scenario, the user invited to the group may accept or reject the invitation to join the group.

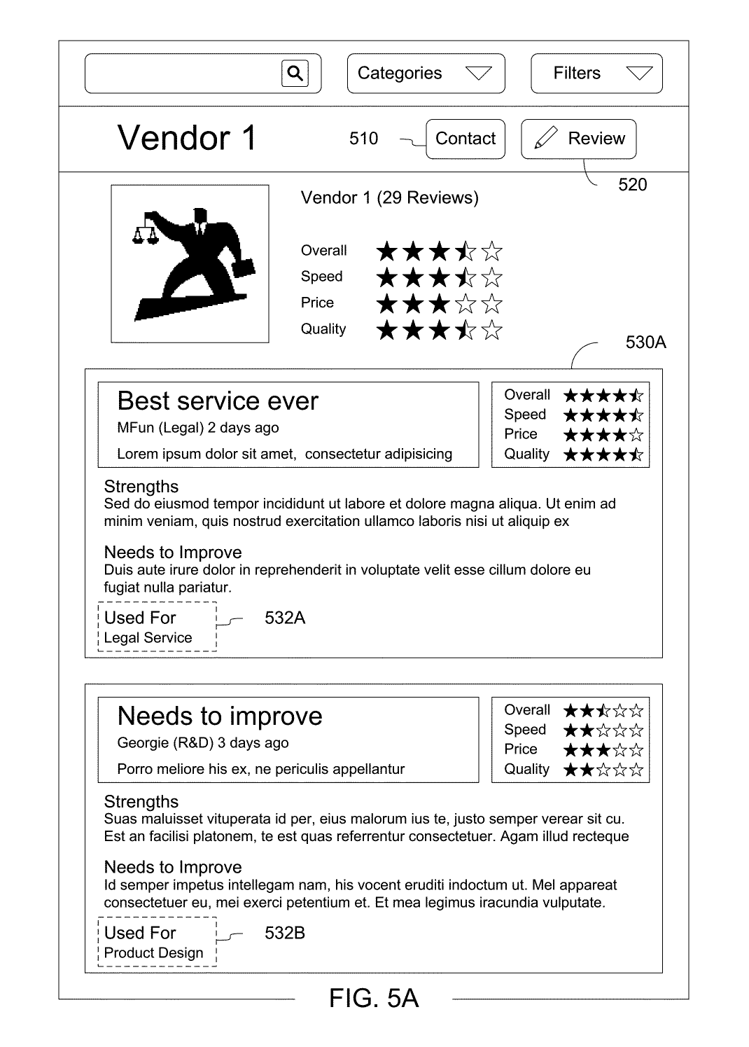

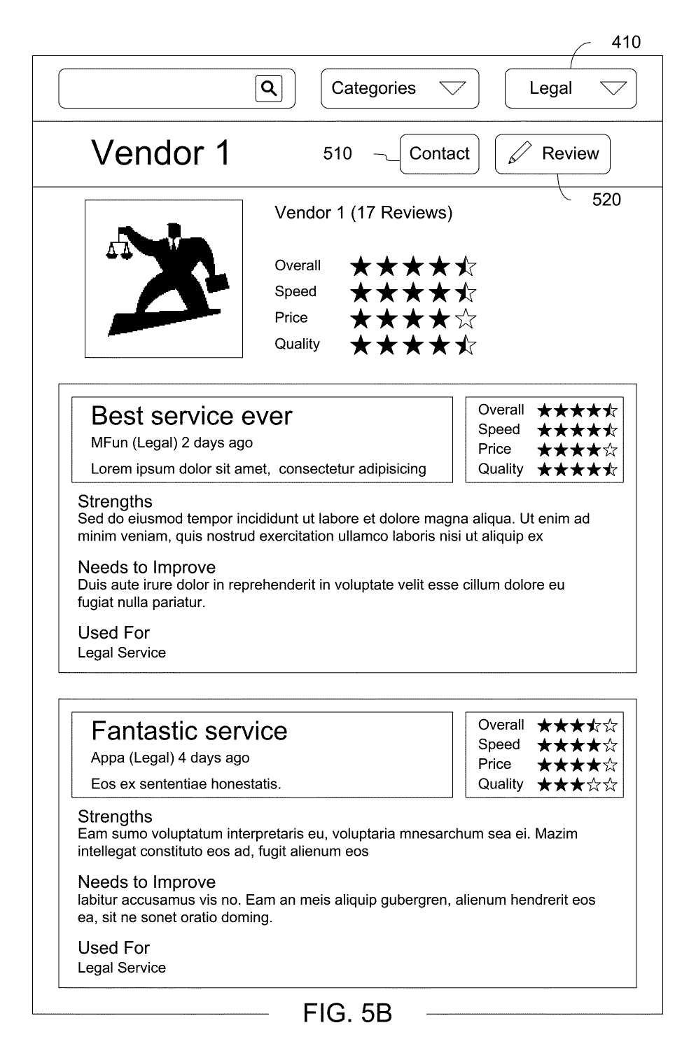

The review store 225 stores reviews provided by users of the vendor referral system 140. The review store 225 may include a rating for the vendor associated with a review (e.g., a one-to-five start rating), a comment from a user about the vendor associated with the review, and indication of the type of business conducted between the user and the vendor associated with the review, and the like. In some embodiments, a review is associated with an industry. This may help to identify which industry of a vendor that is associated with multiple industries the review is directed to. An exemplary review is shown and described further below with reference to FIG. 5A.

The content server 235 links the vendor referral system 140 via the network 120 to the one or more client devices 110, as well as to the professional networking system 130. The content server 235 may for example, provide a user interface to a client device requesting to interact with the vendor referral system 140.

### Dual-Identity Review System

As illustrated in FIG. 3, a user profile 310 includes an anonymous profile 340 and a real profile 320. The vendor referral system 140 allows a user to interact with a first portion of the vendor referral system 140 using the anonymous profile 340 of the user profile 310, and allow the user to interact with a second portion of the vendor referral system 140 using the real profile 320 of the user profile 310. Though termed “portions,” the anonymous and real profiles may be used when interacting with different functions of the vendor referral system 140. The anonymous profile may be used in circumstances where a user may be reluctant to associate real profile information with the interactions. In some embodiments, a user uses the anonymous profile 340 when posting reviews for vendors registered with the vendor referral system 140. The user then uses the real profile 320 to directly interact with vendors registered with the vendor referral system 140. For instance, a user may use the real profile 320 when contacting a vendor to request information for the services the vendor offers.

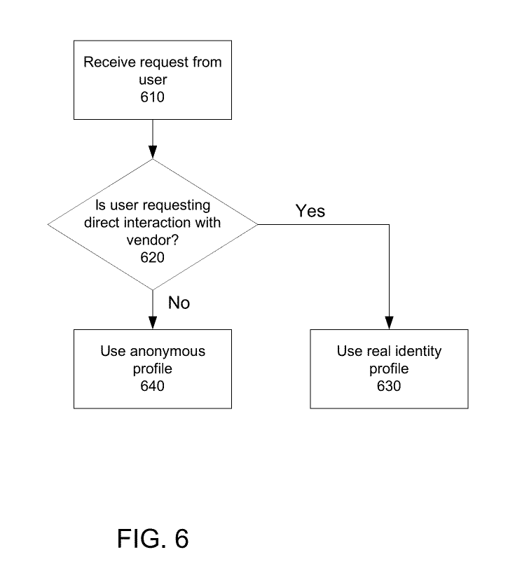

FIG. 6 illustrates a flow diagram of a method for using a dual identity, according to one embodiment of the vendor referral system. A request from a user is received 610.

The vendor referral system 140 determines 620 whether the request is for directly interacting with a vendor. For instance, the vendor referral system 140 determines whether the user is contacting a vendor registered with the vendor referral system 140.

If the vendor referral system 140 determines that the user is requesting an interaction with a vendor, the vendor referral system uses 630 the real identity profile 320 of the user to complete the request. For instance, if the user is directly contacting a vendor (e.g., for enquiring about a service offered by the vendor), the vendor referral system 140 uses the real identity for the interaction between the user and the vendor.

If the vendor referral system 140 determines that the user is not requesting an interaction with a vendor, the vendor referral system uses 640 the anonymous profile 340 for the interaction between the user and the vendor referral system 140. For instance, if the user is providing a review for a vendor, the vendor referral system 140 uses the anonymous profile 340.

In some embodiments, the vendor referral system 140 associates a unique identifier associated with the user profile 310 of a user for every interaction the user has with the vendor referral system and uses the anonymous profile 340 to display the interaction to other users of the vendor referral system if the interaction was not for a direct interaction with a vendor, and uses the real identity profile 320 for displaying the interaction to a vendor if the interaction was for directly interacting with the vendor.

### Review Rules

The vendor referral system 140 may use the information about a user available in the user profile 310 to filter reviews provided by the user. The information about a user providing the review is used to filter reviews for a vendor and ensure that user reviews come from users providing trustworthy reviews of the vendor. Since reviews are displayed in one embodiment using the anonymous profile, this filtering provides reliability to other users that such reviews may be trusted, even if the reviewer is anonymized. As an example of an untrusted review, the vendor referral system 140 may restrict the user from providing reviews for a reviewer that has a conflict of interest with the vendor. As used herein, a user that has a conflict with interest with a vendor is a user that is likely to have a bias when providing comments for the vendor, and thus, it may not provide a trustworthy review.

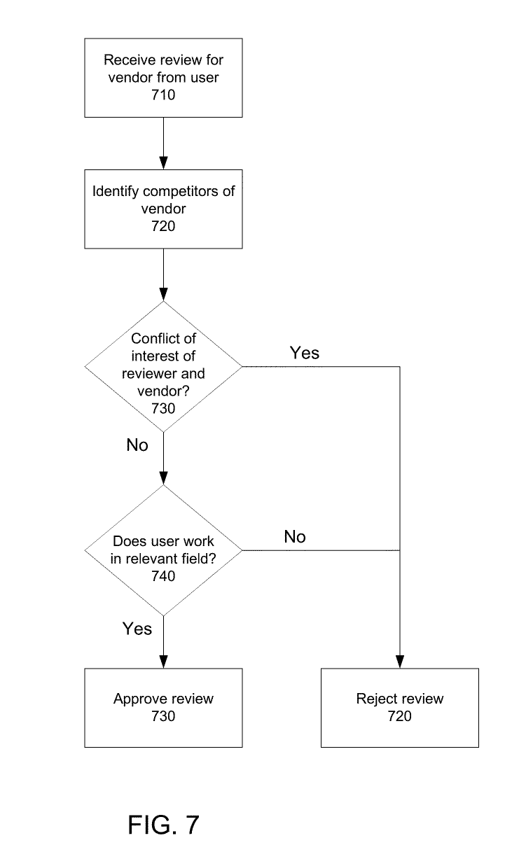

FIG. 7 illustrates a flow diagram of a method for determining the trustworthiness of a user review, according to one embodiment. The vendor referral system 140 may determine the trustworthiness of a user review to determine whether to present the review to other users of the vendor referral system 140. For instance, reviews for a specific vendor that are determined not to be trustworthy may not be presented to users requesting reviews for the specific vendor. First, the vendor referral system 140 receives 710 reviews for a vendor from a user.

Competitors of the vendor associated with the review are identified 720. For instance, a list of competitors for the vendor may be retrieved from the vendor profile store 210.

The vendor referral system 140 determines 730 whether the user providing the review has a conflict of interest with the vendor associated with the review. For instance, the vendor referral system 140 may determine whether the user providing the review works at a competitor of the vendor. The vendor referral system 140 determines whether the user is an employee (or previous employee) of a competitor by consulting the real profile 324 of the reviewer, even though that review may be presented to others using the anonymous profile 340. Users that work in a direct competitor of the vendor may be likely to provide negative reviews for the vendor. For instance, a user that works at a competitor of the vendor may want to decrease the rating of the vendor or may want to prevent the vendor from getting new clients through the vendor referral system 140. The vendor referral system 140 may also determine whether the user works at the vendor. For instance, the vendor referral system 140 may determine whether the user is an employee (or previous employee) of the vendor that is the subject of the review. Users that work at the vendor may be likely to provide good reviews for the vendor. For instance, a user that works at the vendor may want to increase the rating of the vendor or may want to increase the likelihood of the vendor of getting new clients thought the vendor referral system 140.

If the vendor referral system 140 determines that the user has a conflict of interest with the vendor, the vendor referral system 140 rejects 720 the review. In some embodiments, the vendor referral system 140 may flag the review for a manual review or may analyze the contents of the review to determine if the review contains biased content. In other embodiments, the vendor referral system may accept the review and may set a flag that indicates that the review was made by a user that has been identified as having a conflict of interest with the vendor. For example, the vendor referral system may accept the review and display the review to other users of the vendor referral system 140 but indicating that the review was made by a user identified as having a conflict of interest with the vendor and may indicate the reason for the conflict of interest (e.g., that the reviewer works for the vendor or works for a listed competitor of the vendor).

The flag indicating the user that provided the review has a conflict of interest may also be used for sorting the reviews when presenting the reviews to users of the vendor referral system 140. For instance, flagged reviews may be presented after all reviews that have not been flagged have been presented. In some embodiments, a user reading reviews may select whether to be presented with reviews flagged as being provided by a user having a conflict of interest with the vendor.

In one embodiment, the vendor referral system determines 740 whether the user works in a field relevant to the type of business the vendor conducts. The vendor referral system may determine whether the professional information 324 of the user profile 310 of the user and the vendor profile of the vendor are associated with the same industry. If the user is does not work in a field relevant to the type of business the vendor conducts, the vendor referral system 140 rejects 720 the review. For instance, the vendor referral system may reject the review provided by a user that works as a graphics designer for a chip manufacturer vendor.

In some embodiments, the industry associated with the professional information 324 of a user does not have to be the same as an industry associated with the vendor. Instead, the industry associated with the vendor may have a list of industries that are relevant to the industry. For instance, relevant industries for the “chip manufacture” industry may include “digital circuit design,” “amplifier design” Thus, users associated with either the “digital circuit design” industry or the “amplifier design” industry may provide reviews for a vendor associated with the “chip manufacture” industry.

In some embodiments, some industries list every industry as relevant. For instance, the “food catering” industry may list every industry as relevant. Thus, users associated with any industry may provide reviews for vendors associated with the “food catering” industry.

In some embodiments, the vendor referral system 140 may flag the review for a manual review or may analyze the contents of the review to determine if the review contains useful information. In other embodiments, the vendor referral system may accept the review and may set a flag that indicates that the review was made by a user that has been identified as not working in a field that is relevant to the type of business the vendor conducts. For example, the vendor referral system may accept the review and display the review to other users of the vendor referral system 140 but indicating that the review was made by a user identified as not working in a field that is relevant to the type of business the vendor conducts.

The flag indicating the user that provided the review does not work in a field that is relevant to the type of business the vendor conducts may also be used for sorting the reviews when presenting the reviews to users of the vendor referral system 140. For instance, after sorting, the flagged reviews may be presented after all reviews that have not been flagged have been presented. In some embodiments, a user reading reviews may select whether to be presented with reviews flagged as being provided by a user not working in a field that is relevant to the type of business the vendor conducts.

If the vendor referral system 140 determines that the user does not have a conflict of interest with the vendor, and the user works in a field relevant the type of business the vendor conducts, the vendor referral system 140 approves the review 730.

### Site Filter

In one embodiment of the vendor referral system 140, the information displayed by the vendor referral system 140 is filtered by a site filter. As used herein, a site filter is a filter that can be set by a user, and which changes the response of the vendor referral system 140 to interactions and requests sent by a user. For instance, a user may set an industry site filter, a time site filter, a location site filter, etc. The site filter may filter user queries, may be used to modify algorithms for calculating different values used by the vendor referral system 140, may change the elements in a user interface of the vendor referral system 140, and the like.

For example, a user may set a value of the industry site filter. Any interaction the user may have with the vendor referral system may be affected in view of the selected industry site filter. For instance, search results for every search query provided by the user may be filtered and/or sorted based on the set industry site filter, scores for vendors may be computed based on reviews filtered using the set industry site filter, reviews displayed to the user may be filtered based on the industry site filter, etc.

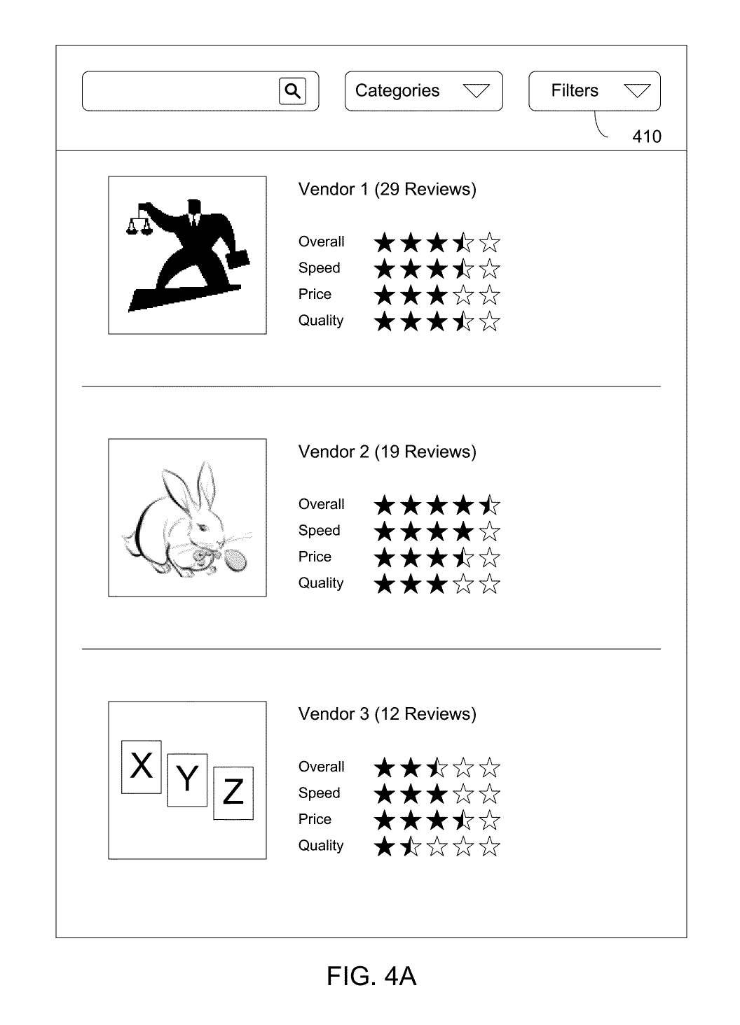

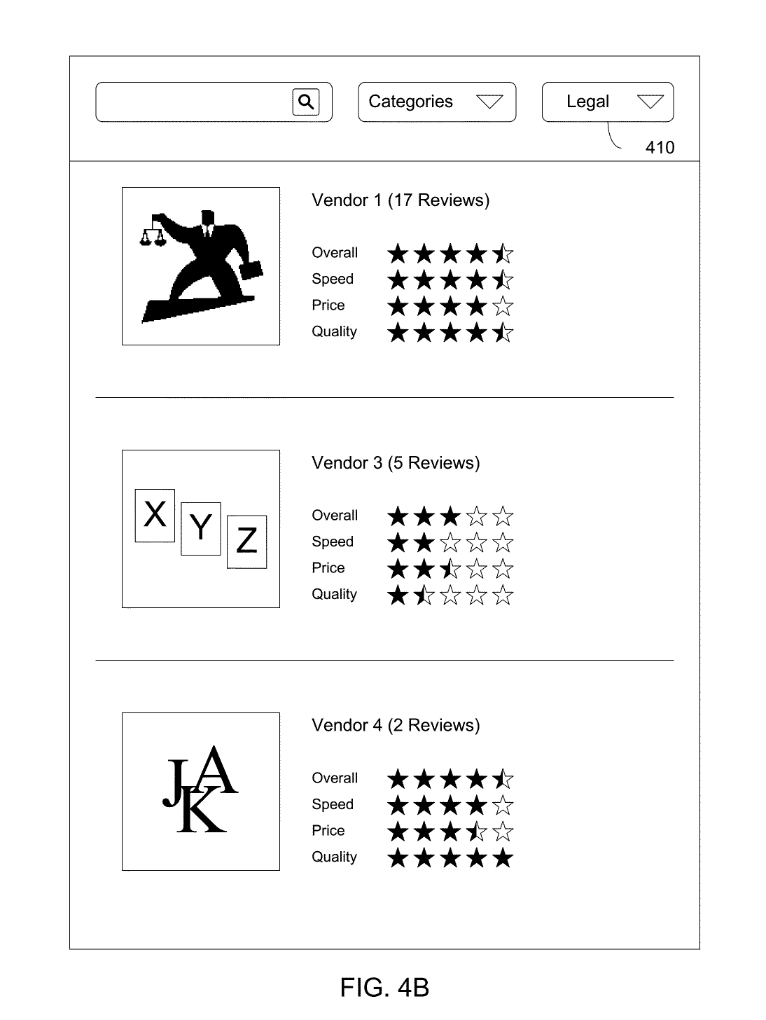

FIG. 4A illustrates a user interface of a vendor search in the vendor referral system, in accordance with an embodiment of the vendor referral system. FIG. 4A shows 3 search results: vendor 1, vendor 2, and vendor 3. Vendor 1 has 29 reviews with an overall star rating of 3.5 stars, a speed rating of 3.5 stars, a price rating of 3 stars and a quality rating of 3.5 stars. Vendor 2 has 19 reviews with an overall star rating of 4.5 stars, a speed rating of 4 stars, a price rating of 3.5 stars and a quality rating of 3 stars. Vendor 3 has 12 reviews with an overall rating of 2.5 stars, a speed rating of 3 stars, a price rating of 3.5 stars and a quality rating of 1.5 stars.

FIG. 4B illustrates the user interface of FIG. 4A with a site filter set to “legal,” in accordance with an embodiment of the vendor referral system. The site filter may, for example, be set by a user via a user interface element 410 (e.g., a drop down list, or a text box). In the user interface of 4B the number of reviews displayed and the star ratings of the vendors are determined based on the site filter “legal.” For example, the vendor referral system 140 may only use reviews from users that are related to the site filer “legal” (e.g., users that work in the legal field, or users that have an education background related to the legal field). For instance, the vendor referral system 140 may only use review from users that are associated with the “legal” industry, or that are associated with an industry that has been identified as relevant for the “legal” industry. In addition, if a vendor is associated with multiple industries, the vendor referral system 140 may only use reviews that are associated with the “legal” industry. As such, for vendor 1, the number of reviews decreased from 29 to 17 and the overall rating changed to 4.5, the speed rating changed to 4.5, the price rating changed to 4 and the quality rating changed to 4.5. For vendor 3, the number of reviews decreased from 12 to 5 and the overall rating changed to 3, the speed rating changed to 2, the price rating changed to 2.5 and the quality rating changed to 1.5. In addition, the search results may be filtered using the site filter. In the example of FIG. 4B, vendor 2 was filtered out from the search results. For instance, vendor 2 may have been a match for a search query provided by the user, but may not have been associated with the industry of the site filter set by the user.

FIG. 5A illustrates a user interface showing reviews for a vendor, in accordance with an embodiment of the vendor referral system. FIG. 5A illustrates details of reviews provided by users for vendor 1. The user interface of FIG. 5A includes a button 520 for a user to provide reviews about the vendor.

The user interface of FIG. 5A includes reviews 530. For example, the user interface of FIG. 5A includes 2 reviews. A first review 530A provided by a user with an anonymous profile “MFun,” and a second review 530B provided by a second user with an anonymous profile “Georgie.”

User with anonymous profile “MFun” provided an overall rating of 4.5 stars, a speed rating of 4.5 stars, a price rating of 4 stars and a quality rating of 4.5 stars. In addition, user with anonymous profile “MFun” specified that vendor 1 was used for “legal services,” as shown in box 532A.

User with anonymous profile “Georgie” provided an overall rating of 2.5 stars, a speed rating of 2 stars, a price rating of 3 stars, and a quality rating of 2 stars. In additions, user with anonymous profile “MFun” specified that vendor 1 was used for “product design.”

In some embodiments, the user interface of FIG. 5A may show the real profile of users that are in the same group as the viewing user. For instance, if the viewing user is associated with the “Asian American Bar Association of the Greater Bay Area” group, the user interface of FIG. 5 would show the real profile of other users that are also associated with the “Asian American Bar Association of the Greater Bay Area” group. For instance, if the user with anonymous profile “Georgie” is associated with the “Asian American Bar Association of the Greater Bay Area” group, the viewing user will be able to see the real profile of the user with anonymous profile “Georgie.”

FIG. 5B illustrates a user interface showing reviews for a vendor with a site filter set to “legal,” in accordance with an embodiment of the vendor referral system. FIG. 5B illustrates details of reviews provided by users for vendor 1 and filtered using the site filter “legal.” The site filter filters the reviews that are displayed to a user. For instance, when a site filter was not set, as illustrated in FIG. 5A, reviews from user with anonymous profile “MFun” who specified that vendor 1 was used for “legal services” and reviews from user with anonymous profile “Georgie” who specified that vendor 1 was used for “product design.” When the site filter is set to “legal,” comments that are not related to “legal” are not show to the user. For instance, the in user interface of FIG. 5B, the review from the user with anonymous profile “Georgie” is not shown to the user.

In some embodiments, the reviews may also be filtered based on attributes other than an industry associated with the review (e.g., the “used for” field 532). For instance, the reviews may be filtered by the expertise or skills of the reviewer. The vendor referral system may filter reviews provided by users that do not have an education in the legal field, that do not have skills in the legal field, and/or that do not work in the legal field. For example, if the site filter is set to “legal,” the vendor referral system may only provide reviews from users that work in the legal field.

In addition, other aspects of the user interface may change in view of the site filter. For instance, the star rating of vendor 1 may be computed using only reviews that are relevant to the site filter “legal.”

In some embodiments, multiple site filters may be set by a user of the vendor referral system 140. For instance, a user may set an industry site filter to “catering,” and a location filter set to “California.” The vendor referral system may then modify the elements displayed to the user based on the set site filters. For instance, every search result may be filtered using the “catering” industry filter and the “California” location filter.

For example, a user may search for vendors using the string “apple.” Without a site filter set, the vendor referral system may return search results for any vendor that is relevant to the string “apple.” For instance, the vendor referral system may include vendors such as “Apple Computers,” “Apple printing,” “Apple & Apple,” “Applebee's, etc.”

If the “catering” industry filter is set, the vendor referral system 140 may filter the search results to exclude vendors that are not associated with catering, such as “Apple Computers,” “Apple printing,” and “Apple & Apple.” Additionally, the reviews and ratings shown for the vendors returned from the search query may also be filtered based on the “catering” industry filter. For instance, the reviews provided to the user may be filtered to only include reviews from users that work in the catering field or have an education in the catering field.

Furthermore, if the “California” location filter is set, the vendor referral system 140 may filter search results to exclude vendors outside of California. Additionally, the reviews and ratings shown for the vendors returned from the search query may also be filtered based on the “California” location filter. For instance, the reviews provided to the user may be filtered to only include reviews from users that work or live in California.

The site filter may be set once by the user and may be kept set until the user changes the site filter. In some embodiments, the site filter may be kept between user sessions of the same user. For instance, a user may set a site filter and use the vendor referral system 140 with the set filter. After finishing using the vendor referral system 140, the user may end the current user session (e.g., by logging out of the vendor referral system, or by closing a browser used to interact with the vendor referral system). At a later time, the user may want to use the vendor referral system again. The user may then open a new user session (e.g., by opening the vendor referral system using a web browser, and/or logging in to the vendor referral system). The vendor referral system may start the new user session with the site setting from the previous user session. In other embodiments, the vendor referral system resets the site filters whenever a new user session is started.

### Vendor Shopping Cart

The vendor referral system 140 may also include a vendor shopping cart. A user browsing through different vendors may be interested in contacting, getting contacted, or getting quotes from multiple vendors. For instance a user searching for “computer manufacturers” may be interested in getting quotes from “Apple,” “Dell,” and “Fujitsu.” Instead of contacting each of the vendors individually, the user may place the vendors in the vendor shopping cart. At a later point in time, during a “check out” process, the user may use the vendor shopping cart to contact every vendor, or requesting quotes from every vendor at once. The vendor referral system may request information from the user to complete the quote request during the “check out” process. For instance, the vendor referral system may request information regarding the type of product or service the user is requesting the quotes for, a preferred mode of communication for the user, the urgency of the quote, etc. The information may be requested from the user once, and may be provided to every vendor included in the vendor shopping cart.

In some embodiments, the user may add the vendor to the vendor shopping cart using a user interface element, such as button 510 of FIG. 5A. The vendor referral system may additionally include a user interface element (not shown in the FIGS.) for a user to initiate the “check out” process. As the user finds vendors the user is interested in, the user may place the vendors in the shopping cart without the user having to disrupt the search by contacting the vendors.

In some embodiments, the vendor referral system 140 saves the contents of the vendor shopping cart until the user checks out the vendor shopping cart. In one embodiment, the vendor referral system 140 may allow users to have multiple shopping carts concurrently. For instance, a user may have a first shopping cart for “food catering” vendors and a second shopping cart for “florist” vendors. In another example a user may have a first shopping cart for a first set of vendors the user is interested in getting quotes from first, and a second shopping cart for vendors the user would like to get quotes from if none of the vendors from the first shopping cart are meet what the user is looking for.

### SUMMARY

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for providing reviews for a vendor through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for anonymizing the identity of a user of an online system, the method comprising:
receiving a request, from a viewing user, to interact with the online system, the viewing user having an anonymized profile and a real profile;
responsive to determining that the request to interact with the online system includes a request to interact with another user of the online system, using the real profile viewing user; and
responsive to determining that the request to interact with the online system does not include a request to interact with another user of the online system, using the anonymized profile of the viewing user.

2. The method of claim 1, wherein the request to interact with another user of the online system includes contacting the other user of the online system.

3. The method of claim 1, wherein the request to interact with another user of the online system includes requesting a quote from the other user of the online system.

4. The method of claim 1, wherein a request to interact with the online system that does not include a request to interact with another user is a request to write a review for another user of the online system.

5. The method of claim 1, wherein a request to interact with the online system that does not include a request to interact with another user is a request to read reviews of another user of the online system.

6. The method of claim 1, wherein the anonymized profile includes an anonymized user name and the real profile includes personal information of the viewing user.

7. The method of claim 6, wherein the personal information is received from an online professional networking system.

8. The method of claim 1, wherein the request to interact with the online system is a request to view reviews associated with a target user, and wherein the method further comprises:
identifying a review associated with target user, the review provided by a reviewing user, the reviewing user having an anonymized profile and a real profile; and
presenting to the viewing user, the identified review and the anonymized profile of the reviewing user.

9. The method of claim 1, wherein the request to interact with the online system is a request to view reviews associated with a target user, and wherein the method further comprises:
identifying a review associated with target user, the review provided by a reviewing user, the reviewing user having an anonymized profile and a real profile;
determining whether the viewing user and the reviewing user are associated with a same group;
responsive to determining that the viewing user and the reviewing user are not associated with the same group, presenting to the viewing user, the identified review and the anonymized profile of the reviewing user; and
responsive to determining that the viewing user and the reviewing user are associated with the same group, presenting to the viewing user, the identified review and the real profile of the reviewing user.

10. A non-transitory computer readable medium configured to store instruction, the instructions, when executed by a processor, causes the processor to:
receive a request, from a viewing user, to interact with the online system, the viewing user having an anonymized profile and a real profile;
responsive to determining that the request to interact with the online system includes a request to interact with another user of the online system, use the real profile viewing user; and
responsive to determining that the request to interact with the online system does not include a request to interact with another user of the online system, use the anonymized profile of the viewing user.

11. The non-transitory computer readable medium of claim 10, wherein the request to interact with another user of the online system includes one selected from the group consisting of: a request to contact the other user of the online system, and a request for a quote from the other user of the online system.

12. The non-transitory computer readable medium of claim 10, wherein a request to interact with the online system that does not include a request to interact with another user is one selected from a group consisting of a request to write a review for another user of the online system, and a request to read reviews of another user of the online system.

13. The non-transitory computer readable medium of claim 10, wherein the anonymized profile includes an anonymized user name and the real profile includes personal information of the viewing user, and wherein the personal information is received from an online professional networking system.

14. The non-transitory computer readable medium of claim 10, wherein the request to interact with the online system is a request to view reviews associated with a target user, and wherein the instruction further cause the processor to:
identify a review associated with target user, the review provided by a reviewing user, the reviewing user having an anonymized profile and a real profile; and
present to the viewing user, the identified review and the anonymized profile of the reviewing user.

15. The non-transitory computer readable medium of claim 10, wherein the request to interact with the online system is a request to view reviews associated with a target user, and wherein the instructions further cause the processor to:
identify a review associated with target user, the review provided by a reviewing user, the reviewing user having an anonymized profile and a real profile;
determine whether the viewing user and the reviewing user are associated with a same group;
responsive to determining that the viewing user and the reviewing user are not associated with the same group, present to the viewing user, the identified review and the anonymized profile of the reviewing user; and
responsive to determining that the viewing user and the reviewing user are associated with the same group, present to the viewing user, the identified review and the real profile of the reviewing user.

16. A system for anonymizing the identity of a user of an online system including:
a processor; and
a non-transitory computer readable medium configured to store instruction, the instruction when executed by the processor, cause the processor to:
receive a request, from a viewing user, to interact with the online system, the viewing user having an anonymized profile and a real profile;
responsive to determining that the request to interact with the online system includes a request to interact with another user of the online system, use the real profile viewing user; and
responsive to determining that the request to interact with the online system does not include a request to interact with another user of the online system, use the anonymized profile of the viewing user.

17. The system of claim 16, wherein the request to interact with another user of the online system includes one selected from the group consisting of: a request to contact the other user of the online system, and a request for a quote from the other user of the online system.

18. The system of claim 16, wherein a request to interact with the online system that does not include a request to interact with another user is one selected from a group consisting of a request to write a review for another user of the online system, and a request to read reviews of another user of the online system.

19. The system of claim 16, wherein the anonymized profile includes an anonymized user name and the real profile includes personal information of the viewing user, and wherein the personal information is received from an online professional networking system.

20. The system of claim 16, wherein the request to interact with the online system is a request to view reviews associated with a target user, and wherein the instructions further cause the processor to:
identify a review associated with target user, the review provided by a reviewing user, the reviewing user having an anonymized profile and a real profile;
determine whether the viewing user and the reviewing user are associated with a same group;
responsive to determining that the viewing user and the reviewing user are not associated with the same group, present to the viewing user, the identified review and the anonymized profile of the reviewing user; and
responsive to determining that the viewing user and the reviewing user are associated with the same group, present to the viewing user, the identified review and the real profile of the reviewing user.
